(19) United States
(12) Patent Application Publication
(10) Pub. No.: US 2007/0189578 A1
(43) Pub. Date: Aug. 16, 2007

(54) Computer-implemented method and system for perceptual cryptography in file-sharing environments

(75) Inventor: Andres M. Torrubia, Alicante (ES)

Correspondence Address: SCHWEGMAN, LUNDBERG, WOESSNER & KLUTH, P.A., P.O. BOX 2938, MINNEAPOLIS, MN, 55402, US

(73) Assignee: Macrovision Corporation

(21) Appl. No.: 11/394,958

(22) Filed: Mar. 31, 2006

Related U.S. Application Data
(60) Provisional application No. 60/684,778, filed on May 25, 2005.

(51) Int. Cl. G06K 9/00

(52) U.S. Cl. 382/100

(57) ABSTRACT

A computer-implemented method and system for perceptual cryptography in file-sharing environments are disclosed. The method and system include providing access to a quality-degraded version of a content bit-stream, and providing decryption keys for rendering the content bit-stream without quality degradation.

### CROSS-REFERENCE TO PRIORITY PATENT APPLICATIONS

This patent application claims the benefit of the filing date of U.S. Provisional Patent Application Ser. No. 60/684,778 filed May 25, 2005, and entitled, “Perceptual Cryptography in File-Sharing Environments,” which is incorporated herein by reference.

### BACKGROUND

2. Technical Field

This disclosure relates to cryptography methods and systems. More particularly, the present disclosure relates to the use of perceptual cryptography in file-sharing environments.

3. Related Art

Peer-to-Peer distributed applications are emerging as a result of fast development of the Internet network. These systems must manage, in an effective and secure way, the computer resources and the data. In such a context, the heterogeneity (data structure, data. sources, software, and hardware), the decentralization, the location, the access and the availability of the resources (i.e. programs, network bandwidth, data) present a real challenge to the development of large distributed systems in a secure environment. Recent advances in this area involve the design and development of new methods and techniques that offer users a transparent, effective and secured access to resources of large-scale heterogeneous distributed information. This is the case of peer-to-peer based systems such as video on demand, broadcasting, and digital rights management.

One of the most popular applications of peer-to-peer networks is file sharing. In this application, users share a subset of the files stored in their computers, which become readily available for direct downloading to other users, often resulting in copyright violations as copyrighted works such as music, video and images are illegally distributed across the network. In these systems, the commercial value of digital images makes image compression and multimedia security increasingly important problems to be solved. A lot of effort has been put into the development of image compression schemes that achieve low bits-per-pixel rates while preserving image quality to speed up transfers.

Today, one of the most widely available image compression formats is the JPEG (Joint Photographic Experts Group) standard. JPEG images arc commonly stored using the JFIP (JPEG File Interchange Format). The JPEG format does not provide native support for encryption. Conventional cryptography has focused on providing confidentiality, integrity, and authentication; but fails to provide efficient schemes for peer-to-peer transactional commerce in digital multimedia files. Applying conventional encryption algorithms on JPEG compressed images results in cipher-text that cannot be displayed meaningfully. Such cipher-text has little value if not in possession of the decryption key.

Thus, a computer-implemented method and system for perceptual cryptography in file-sharing environments are needed.

### BRIEF DESCRIPTION OF THE DRAWINGS

Embodiments illustrated by way of example and not limitation in the figures of the accompanying drawings, in which:

FIG. 1 illustrates perceptual encryption and decryption processes of one embodiment.

FIG. 2 depicts a JPEG encoding process.

FIG. 3 depicts the JPEG Interchange Format structure.

FIG. 4 illustrates a flow chart showing the basic processing operations performed in an embodiment.

FIG. 5 is a sample image prior to the application of the processing described herein.

FIGS. 6-8 are image samples produced as a result of one embodiment.

FIG. 9 shows the PSNR between an original sample image JPEG and its resulting encrypted counterparts.

FIG. 10 depicts a practical scenario in which an image and key server provides encrypted images to end-users.

FIG. 11 is a block diagram of a network system on which various embodiments may operate.

FIGS. 12a and 12b are a block diagram of a computer system on which various embodiments may operate.

### DETAILED DESCRIPTION

A computer-implemented method and system for perceptual cryptography in file-sharing environments are disclosed. In the following description, numerous specific details are set forth. However, it is understood that embodiments may be practiced without these specific details. In other instances, well-known processes, structures and techniques have not been shown in detail in order not to obscure the clarity of this description. As described in detail below in relation to several example embodiments, we present perceptual cryptography applied to JPEG (Joint Photographic Experts Group) compressed images. Embodiments support a backward compatible format-compliant JFIF (JPEG File Interchange Format) encryption technique that allows for the graceful degradation of compressed images with both configurable ZoE (zone of encryption) and quality loss. Other embodiments support the graceful degradation of other forms of content including audio, music, film, video, graphics, animation, digital text files, and the like. The embodiments described and claimed herein can be applied to content encoded in various formats including, but not limited to, Moving Picture Experts Group (MPEG) formats such as MPEG-2 and MPEG-4. In addition, embodiments herein support content encoded and retained in various file formats. Audio or music files can be identified by the file extensions including, for example, .mp3, .wav, .wma, .asf, .aac, .ogg, and aiff, among others. Film or video files can be identified by the file extensions including, for example, .vob, .asx, avi, .mov, .wmv, asf, .divx, .ivf, .qt, .swv, fla, .mpeg, and .mpg, among others.

Applications include encrypted image sampling and purchase by customers using existing JPEG viewers or other content viewers via broadcasting, peer-to-peer network seeding or web-based publishing.

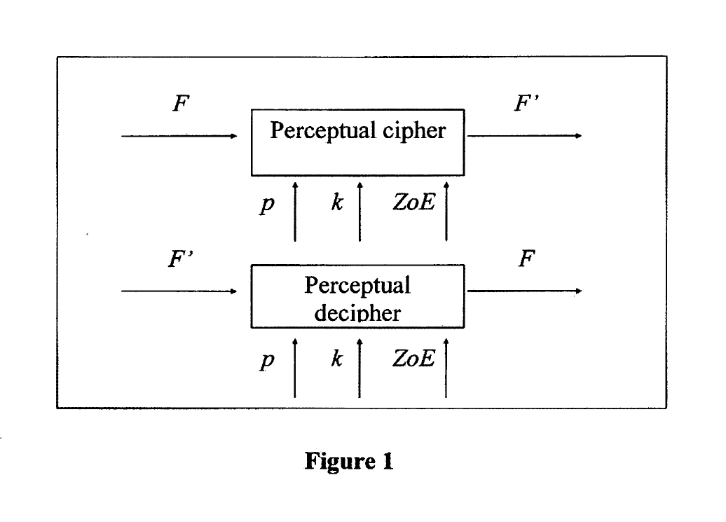

The perceptual encryption and decryption processes of one embodiment are depicted in FIG. 1. Although the embodiment described below uses a content bit-stream encoded in a JPEG format, it will be apparent to those of ordinary skill in the art that the other content formats, examples of which are listed above, can equivalently be used with various embodiments. Referring to FIG. 1, the inputs of one embodiment of the encryption process include the following:

1. Multimedia plain-text F, belonging to the set Ω of multimedia data compliant with some particular bit-stream format (e.g. JPEG).

2. Quality loss pε[0, 100] that should be applied to the original multimedia plain-text.

3. Encryption key to be used. k [0, 2ⁿ].

4. Zone of Encryption ZoE: rectangle (x0,y0)-(x1,y1) to which encryption is to be applied.

The perceptual encryption process of an embodiment receives these inputs and produces an output of the encryption process as follows:

1. Multimedia cipher-text F′ is produced with the same perceptual information as F, degraded as specified by the quality loss input p. This data preserves the same bit-stream format as the input multimedia plain-text (F′εΩ).

Conversely, the perceptual decryption process of one embodiment also illustrated in FIG. 1 uses the same parameters as the perceptual encryption process; except, the quality loss percentage p is now the percentage by which the input bit-stream was degraded.

Applying perceptual encryption to F with key k and a quality loss of p and perceptually decrypting the result with k and p will return the original multimedia text F.

In various embodiments, the specific requirements of perceptual cryptography are as follows:

1. The encryption and decryption process should be format invariant.

2. Quality degradation must be granular and monotonic.

3. Encryption must be secure in the sense that it should not be computationally feasible to recover a high quality version of the cipher-text without knowing the encryption key k.

Because the various multimedia formats are unlikely to be compatible at the bit-stream level (i.e. different audio and image formats have unique data structures), each multimedia format will most likely require a dedicated implementation of the perceptual cipher/decipher.

The perceptual cryptography process of various embodiments can be applied to well-known JPEG/JFIF bit-streams. Such an embodiment is described in more detail below.

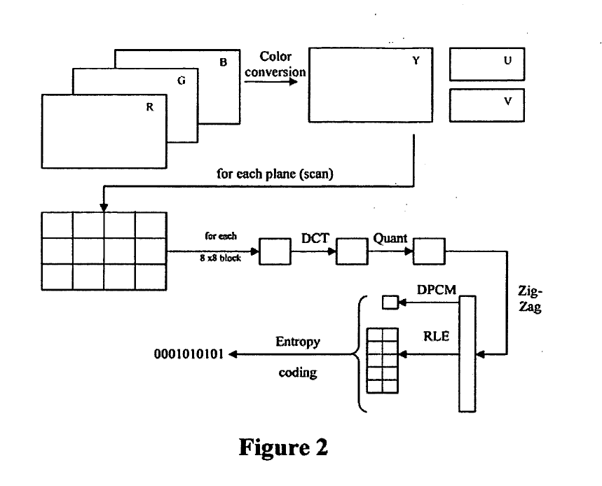

FIG. 2 depicts JPEG encoding process. The JPEG decoding process uses the same primitives as shown in reverse order.

The encoder performs the following steps:

1. Color space conversion: The source image is converted to YUV color space, or grayscale for single component images.

2. Forward discrete cosine transform (FDCT): Each component's samples are grouped into 8×8 blocks, and each block is transformed into a set of 64 values conventionally referred to as DCT coefficients. The first coefficient is referred to as the DC coefficient and the other 63 as the AC coefficients.

3. Quantization: Each of the 64 coefficients is quantized using quantization tables. Quantization is the major source of quality loss in JPEG encoding.

Entropy coding: The DC coefficient is coded differentially using a previous DC coefficient, then further encoded using Huffman entropy coding. For the AC coefficients, the magnitude of the current AC coefficient and the number of subsequent zero AC coefficients is coded using a Huffman table. Remaining information to code each AC coefficient is sent without entropy coding. Alternatively, arithmetic compression may be used instead of Huffman compression.

Compressed image data are described by a uniform structure and set of parameters. The various parts of the compressed image data are identified by special two-byte codes called markers (in the form 0xFFnn-nn being other than zero). If the byte 0xFF is to appear in the bit-system other than in a marker, the byte must be followed by byte 0x00. The bit system parser will discard the 0x00 byte upon the read.

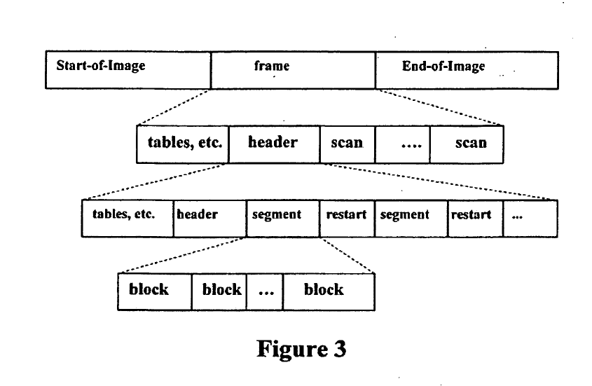

FIG. 3 depicts the JPEG Interchange Format structure. The JFIF format is compatible with the JPEG Interchange Format with the additional requirements of a special marker right after the start-of-image marker. In addition, JFIF assumes YUV color space for 3-component images and grayscale for 1-component images. Both JFIF and the JPEG Interchange Format require all table specifications to be sent in the bit-stream prior to their use.

In various embodiments described and claimed herein, a perceptual cipher transforms AC coefficients that fall inside the zone of encryption. Each AC coefficient will have a probability close top (quality loss) of being encrypted. Embodiments support Huffman entropy coding, but typically not arithmetic entropy coding.

Both the perceptual cipher and perceptual decipher of one embodiment perform operations including the following:

1. Initialize a PRNG (pseudo-random number generator) called PRNGₚ with a non-secret value.

2. Initialize a secure keyed PRNG called PRNGₖ with the secret key k.

3. Parse the Huffman table specifications, both the AC and DC tables.

4. For each 8×8 block, determine if the block falls under the ZoE. If the block falls inside the ZoE, go to the next step; otherwise skip the bit-stream until the next block and repeat this step until the bit-stream ends.

5. Skip the DC coefficient.

6. If there are pending AC coefficients on the current block, go to the next step; otherwise go back to step 4.

7. If the output of PRNGₚ mod 100 is less than p (quality loss), go back to the previous step; otherwise continue to the next step.

8. Fetch the value bits of the current AC coefficient (right after the Huffman code-word). If any bit of the value spans across a 0xFF byte in the bit-stream, go back to step 6.

9. Perform an exclusive or (XOR} operation on the value bits and the output of PRNGₖ.

10. Put the modified bytes back into the bit-stream, unless any of these bytes are 0xFF. Go back to step 4.

Security is achieved by using a keyed PRNG, as well-known to those of ordinary skill in the art. The embodiments described herein do not attempt to modify any 0xFF byte in the bit-stream; otherwise, modification will break sync as non-marker 0xFF bytes are followed by a 0x00 byte, which would have to be removed thereby producing a result that would not conform to the size-invariance requirement specified above. Step 8 described above implements this requirement.

Conversely, even if feeding PRNGₖ with a wrong key, step 10 prevents the process from breaking sync by incorrectly deciphering a byte into 0xFF.

In some embodiments, the DC coefficients are left untouched. It would be desirable to modify the DC coefficients, as this would provide a great image variance upon manipulation. However, DC coefficients are coded differentially (DPCM) between restart markers, thus making isolated modification of single DC coefficients not feasible in some embodiments.

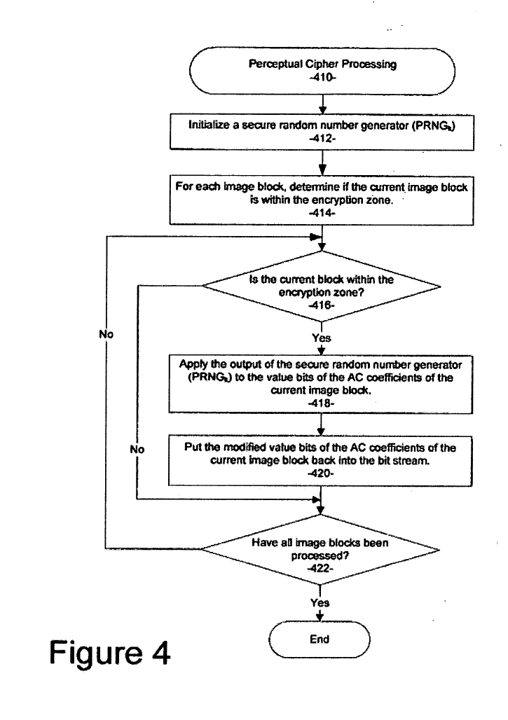

Referring to FIG. 4, a flow diagram of one embodiment is illustrated. The embodiment starts by initializing a secure random number generator PRNGₖ in processing block 412. For each image block in the bit-stream, the embodiment determines if the current image block is within the encryption zone (processing block 414). If the current image block is within the encryption zone (decision block 416), processing passes to processing block 418. At processing block 418, the output of the secure random number generator PRNGₖ is applied to the value bits of the AC coefficients of the current image block. In one embodiment, the output of the secure random number generator PRNGₖ is exclusive or-ed (XOR) with the value bits of the AC coefficients of the current image block to produce a modified image block. In processing block at 420, the modified value bits of the AC coefficients of the current image block are put back into the bit-stream. Similar processing is performed for each image block of the bitstream until all image blocks have been processed (decision block of 422). Referring to decision block 416, if the current block is not within the encryption zone, the current block is left alone and processing continues with the next block in the bitstream until all image blocks have been processed. The perceptual cipher processing then terminates at the end bubble shown in FIG. 4.

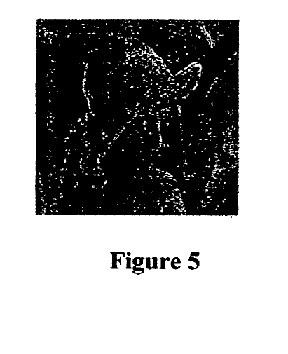

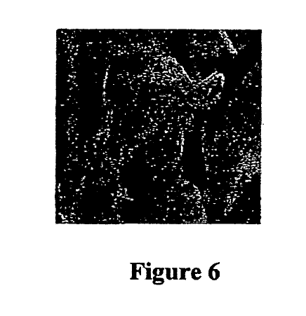

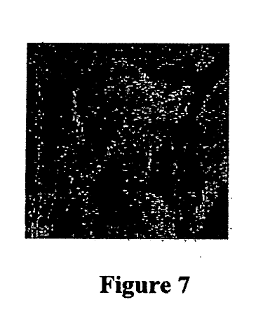

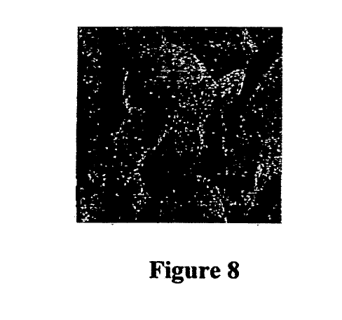

FIG. 5 is a sample image prior to the application of the processing described herein. FIG. 5 is a sample JPEG unencrypted image, consisting of 512×512 pixels and encoded at 5.76 bits-per-pixel (bpp). FIGS. 6-8 are image samples produced as a result of one embodiment. FIG. 6 shows the resulting sample image encrypted with a centered zone of encryption, a quality loss p=100%, and a PSNR=23.98 (dB). FIG. 7 shows the resulting sample image encrypted with a total zone of encryption (full image), a quality loss p=100%, and a PSNR=26.54 (dB). FIG. 8 shows the resulting sample image encrypted with a total zone of encryption (full image), a quality loss p=30%, and a PSNR=26.54 (dB).

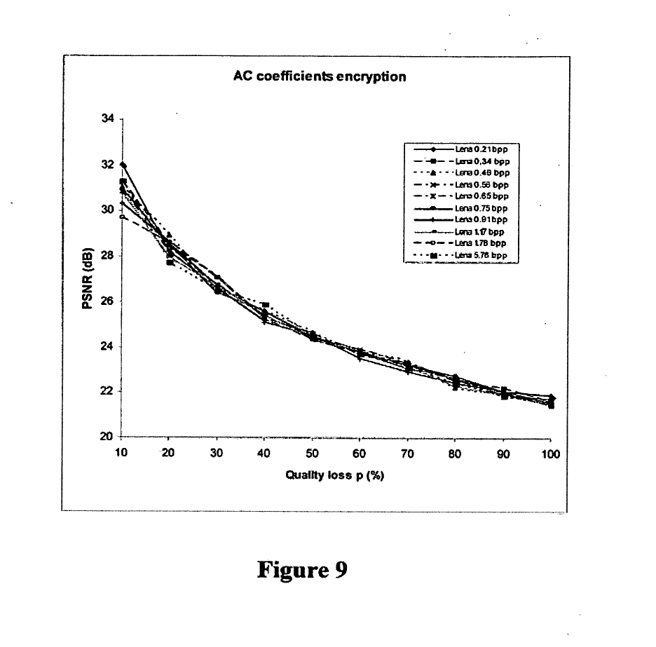

FIG. 9 shows the PSNR between the original sample image JPEG compressed at different bits-per-pixel (b.p.p) and its encrypted counterparts using full image zone of encryption and variable quality loss p. Note that the PSNR does not vary significantly across different bits-per-pixel images.

Our novel perceptual cryptography system and method can be used in a variety of applications. As one example, various embodiments offer the possibility of encrypting images and seeding them across peer-to-peer networks.

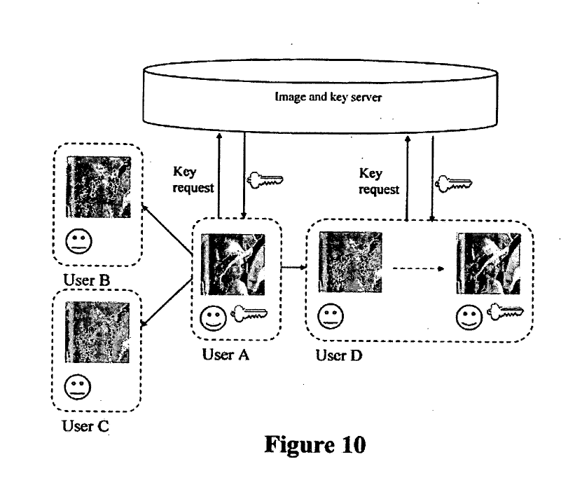

FIG. 10 depicts a practical application of one embodiment in which an image and key server provides encrypted content (e.g. images) to end-users. In this embodiment, an encrypted content repository (e.g. encrypted image repository) and a server accessible to the encrypted image repository is provided. The server provides at least two levels of access to images in the encrypted image repository. A first access level provides decryption keys for rendering an image from the encrypted image repository without quality degradation. A second access level provides access to the encrypted image repository for rendering an image from the encrypted image repository with quality degradation. As shown in FIG. 10, image and key server 1010 acts as an encrypted image repository and as a content clearinghouse providing decryption keys upon authentication or commerce transactions. In one example embodiment, user A shown in FIG. 10 downloads an encrypted image freely available from the image and key server 1010. User A may share the encrypted image with other users B, C, and D using peer-to-peer file sharing or any other available conventional file-sharing technology. At any point, users may contact the key server 1010 to retrieve a decryption key to render the image without quality degradation. FIG. 10 shows that users A and D have retrieved a decryption key from key server 1010 and are able to render the image in full quality. Users B and D do not have such decryption keys and, while they cannot render the image in full quality, they can render the quality-degraded version using off-the-shelf JPEG viewers and may subsequently share the quality-degraded encrypted images.

Most of today's software-based JPEG viewers feature a plug-in based architecture that allows for on-demand download of new plug-ins. Our perceptual decipher could be downloaded after the end-user decides to access the non-degraded version of the bit-stream. Furthermore, the nature of peer-to-peer networks would allow the survival of quality-degraded (encrypted) bit-streams as opposed to their conventionally encrypted versions, as the perceived value of the perceptually encrypted bit-stream is not zero.

Applications may save service-specific information (such as an image-specific URL) with the location of the image and key server 1010 that issues decryption keys into APPO JFIF markers. The aforementioned URL can be used to provide the consumer with information on how to access the non-degraded bit-stream (i.e. retrieving the decryption keys and the necessary plug-ins or modules for perceptual decryption, if necessary).

On the security side, the same care must be taken to safely store and manage perceptual decryption keys as their conventional counterparts. Binding the decryption keys to physical media or unique display device instances may increase security. Furthermore, broadcast encryption may be used to allow unauthorized devices to render degraded versions of bit-streams instead of disabling them altogether.

Moreover, our perceptual cryptography scheme offers security advantages over time-based or metered trial-access applications as the consumer is allowed to sample the content without having any knowledge of the decryption keys.

As disclosed herein, perceptual cryptography embodiments for JPEG/JFIF compressed images are described. Our results show that perceptual cryptography is beneficial on, for example, JPEG/JFIF compressed images. Perceptual cryptography offers interesting applications in peer-to-peer file-sharing networks.

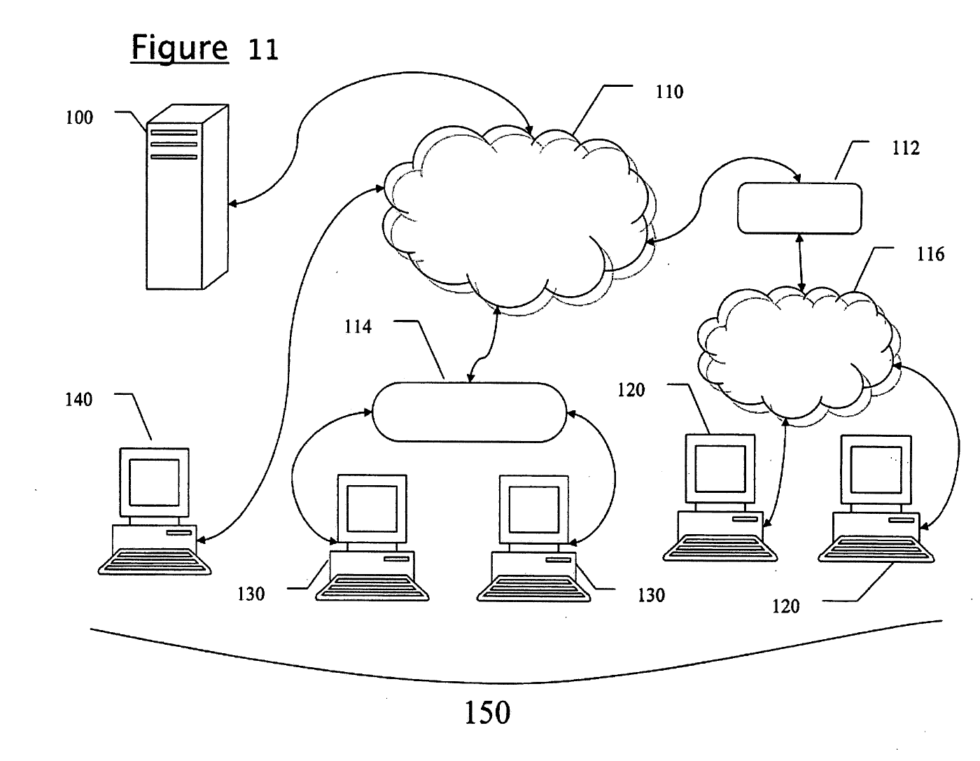

Referring now to FIG. 11, a diagram illustrates the network environment in which various embodiments can operate. In this conventional network architecture, a server computer system 100 is coupled to a wide-area network 110. Wide-area network 110 includes the Internet, or other proprietary networks, which are well known to those of ordinary skill in the art. Wide-area network 110 may include conventional network backbones, long-haul telephone lines, Internet service providers, various levels of network routers, and other conventional means for routing data between computers. Using conventional network protocols, server 100 may communicate through wide-area network 110 to a plurality of client computer systems 120, 130, 140 connected through wide-area network 110 in various ways. For example, client 140 is connected directly to wide-area network 110 through direct or dial-up telephone or other network transmission line. Alternatively, clients 130 may be connected through wide-area network 110 using a modem pool 114. A conventional modem pool 114 allows a plurality of client systems to connect with a smaller set of modems in modem pool 114 for connection through wide-area network 110. In another alternative network topology, wide-area network 110 is connected to a gateway computer 112. Gateway computer 112 is used to route data to clients 120 through a local area network (LAN) 116. In this manner, clients 120 can communicate with each other through local area network 116 or with server 100 through gateway 112 and wide-area network 110.

Using one of a variety of network connection means, server computer 100 can communicate with client computers 150 using conventional means. In a particular implementation of this network configuration, a server computer 100 may operate as a web server if the Internet's World-Wide Web (WWW) is used for wide area network 110. Using the HTTP protocol and the HTML coding language across wide-area network 110, web server 100 may communicate across the World-Wide Web with clients 150. In this configuration, clients 150 use a client application program known as a web browser such as the Internet Explorer™ published by Microsoft Corporation of Redmond, Wash., the user interface of America On-Line™, or the web browser or HTML renderer of any other supplier. Using such conventional browsers and the World-Wide Web, clients 150 may access image, graphical, and textual data provided by web server 100 or they may run Web application software. Conventional means exist by which clients 150 may supply information to web server 100 through the World-Wide Web 110 and the web server 100 may return processed data to clients 150.

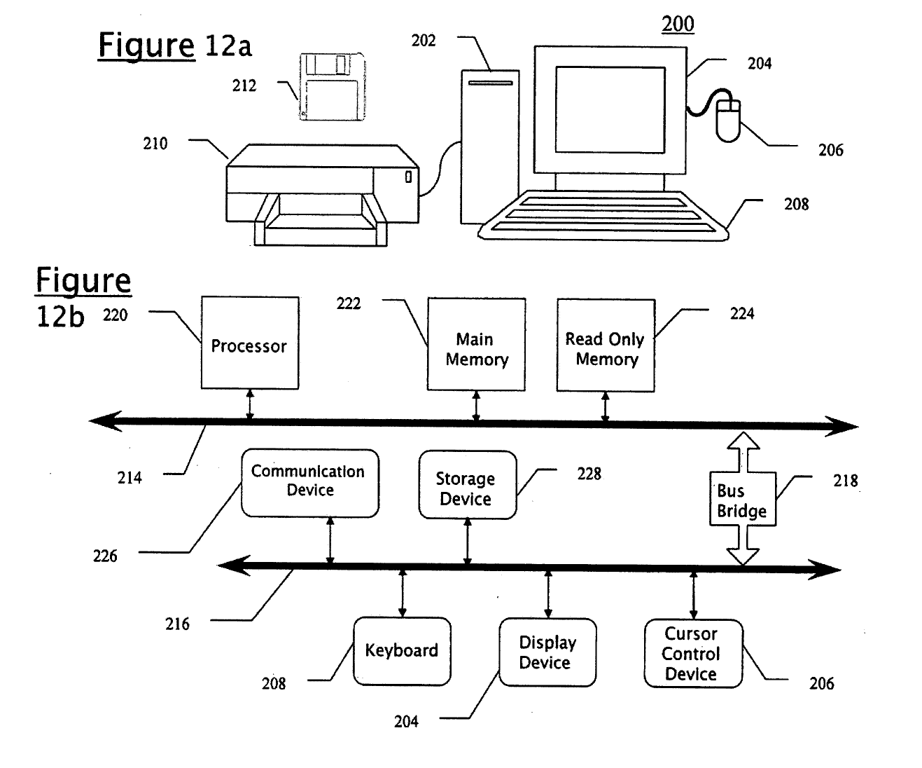

Having briefly described one embodiment of the network environment in which various embodiments may operate, FIGS. 12a and 12b show an example of a computer system 200 illustrating an exemplary client 150 or server 100 computer system in which the features of various embodiments may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and/or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 150 can be implemented as a network computer or thin client device. Client 150 may also be a laptop or palm-top computing device, such as the Palm Pilot™. Client 150 could also be implemented in a robust cellular telephone, where such devices are currently being used with Internet micro-browsers. Such a network computer or thin client device does not necessarily include all of the devices and features of the above-described exemplary computer system; however, the functionality of various embodiments or a subset thereof may nevertheless be implemented with such devices.

A communication device 226 is also coupled to bus 216 for accessing remote computers or servers, such as web server 100, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 100 via a conventional network infrastructure such as the infrastructure illustrated in FIG. 11 and described above.

The system of various embodiments includes software, information processing hardware, and various processing steps, which will be described below. The features and process steps of various embodiments may be embodied in machine or computer executable instructions. The instructions can be used to cause a general purpose or special purpose processor, which is programmed with the instructions to perform the steps of various embodiments. Alternatively, the features or steps of various embodiments may be performed by specific hardware components that contain hard-wired logic for performing the steps, or by any combination of programmed computer components and custom hardware components. While various embodiments will be described with reference to the Internet, the method and apparatus described herein is equally applicable to other network infrastructures or other data communications systems.

It should be noted that the methods described herein do not have to be executed in the order described, or in any particular order. Moreover, various activities described with respect to the methods identified herein can be executed in repetitive, simultaneous, recursive, serial, or parallel fashion. Information, including parameters, commands, operands, and other data, can be sent and received in the form of one or more carrier waves through communication device 226.

Upon reading and comprehending the content of this disclosure, one of ordinary skill in the art will understand the manner in which a software program can be launched from a computer-readable medium in a computer-based system to execute the functions defined in the software program described above. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those of ordinary skill in the art, such as application program interfaces or inter-process communication techniques, including remote procedure calls. The teachings of various embodiments are not limited to any particular programming language or environment, including HTML and XML.

Various embodiments are described. In particular, the use of embodiments with various types and formats of user interface presentations may be described. It will be apparent to those of ordinary skill in the art that alternative embodiments of the implementations described herein can be employed and still fall within the scope of the claims set forth below. In the detail herein, various embodiments are described as implemented in computer-implemented processing logic denoted sometimes herein as the “Software”. As described above, however, the claimed invention is not limited to a purely software implementation.

Thus, a computer-implemented method and system for perceptual cryptography in file-sharing environments are disclosed. While the present invention has been described in terms of several example embodiments, those of ordinary skill in the art will recognize that the present invention is not limited to the embodiments described, but can be practiced with modification and alteration within the spirit and scope of the appended claims. The description herein is thus to be regarded as illustrative instead of limiting.

We claim:

1. A method comprising:
providing access to a quality-degraded version of a content bit-stream; and
providing decryption keys for rendering the content bit-stream without quality degradation.

2. The method as claimed in claim 1 wherein the quality-degraded version of the content bit-stream is degraded to a pre-determined level.

3. The method as claimed in claim 1 wherein the content bit-stream is a JPEG bit-stream.

4. The method as claimed in claim 1 wherein the content bit-stream is a JFIF bit-stream.

5. The method as claimed in claim 1 including accessing a key server to obtain the decryption keys.

6. The method as claimed in claim 1 including using a plug-in component to obtain the decryption keys.

7. The method as claimed in claim 1 wherein the decryption keys are bound to a specific physical device.

8. The method as claimed in claim 1 wherein the decryption keys are bound to a specific physical medium.

9. The method as claimed in claim 1 wherein the content bit-stream is an MPEG bit-stream.

10. An article of manufacture embodied as a machine-accessible medium including data that, when accessed by a machine, causes the machine to perform operations comprising:
providing access to a quality-degraded version of a content bit-stream; and
providing decryption keys for rendering the content bit-stream without quality degradation.

11. The article of manufacture as claimed in claim 10 wherein the quality-degraded version of the content bit-stream is degraded to a pre-determined level.

12. The article of manufacture as claimed in claim 10 wherein the content bit-stream is a JPEG bit-stream.

13. The article of manufacture as claimed in claim 10 wherein the content bit-stream is a JFIF bit-stream.

14. The article of manufacture as claimed in claim 10 including accessing a key server to obtain the decryption keys.

15. The article of manufacture as claimed in claim 10 including using a plug-in component to obtain the decryption keys.

16. The article of manufacture as claimed in claim 10 wherein the decryption keys are bound to a specific physical device.

17. The article of manufacture as claimed in claim 10 wherein the decryption keys are bound to a specific physical medium.

18. The article of manufacture as claimed in claim 10 wherein the content bit-stream is an MPEG bit-stream.

19. A system comprising:
an encrypted content repository; and
a server accessible to the encrypted content repository, the server providing at least two levels of access to content in the encrypted content repository, a first access level providing decryption keys for rendering content from the encrypted content repository without quality degradation, a second access level providing access to the encrypted content repository for rendering content from the encrypted content repository with quality degradation.

20. The system as claimed in claim 19 wherein the decryption keys are bound to a specific physical device.

21. The system as claimed in claim 19 wherein the content is JPEG content.

22. The system as claimed in claim 19 wherein the content is MPEG content.

23. A system comprising:
an encrypted content repository providing access to encrypted content; the encrypted content being renderable with a pre-determined level of quality degradation; and
a server accessible to the encrypted content repository, the server providing decryption keys for rendering encrypted content from the encrypted content repository without quality degradation.

24. The system as claimed in claim 23 wherein the decryption keys are bound to a specific physical device.

25. The system as claimed in claim 23 wherein the encrypted content is JPEG content.

26. The system as claimed in claim 23 wherein the encrypted content is MPEG content.

27. A system comprising:
an encrypted content repository providing access to encrypted content; the encrypted content being renderable with a predetermined level of quality degradation; and
a plug-in component providing access to decryption keys for rendering encrypted content from the encrypted content repository without quality degradation.

28. The system as claimed in claim 21 wherein the decryption keys are bound to a specific physical device.

29. The system as claimed in claim 27 wherein the encrypted content is JPEG content.

30. The system as claimed in claim 27 wherein the encrypted content is MPEG content.
